(19) United States
(12) Patent Application Publication
(10) Pub. No.: US 2025/0275534 A1
(43) Pub. Date: Sep. 4, 2025

(54) EFFERVESCENT GERMICIDAL COMPOSITIONS

(71) Applicant: Reckitt & Colman (Overseas) Hygiene Home Limited, Slough, Berkshire (GB)

(72) Inventors: Kapim Kumar BAGGA, Jr., Montvale, NJ (US); Artur Stanislaw DOMANSKI, Montvale, NJ (US); Dalmacio JUGARAP, Montvale, NJ (US)

(21) Appl. No.: 18/262,277

(22) PCT Filed: Feb. 22, 2022
(86) PCT No.: PCT/GB2022/050495

§ 371 Date: Jul. 20, 2023

(30) Foreign Application Priority Data
Feb. 22, 2021 (GB) 2102475.7

(51) Int. Cl. A01N 25/34; A01N 25/16; A01N 25/30; A01N 33/12; A01P 1/00

(52) U.S. Cl. CPC A01N 25/34; A01N 25/16; A01N 25/30; A01N 33/12; A01P 1/00

(57) ABSTRACT

The present invention provides for effervescent solid compositions for cleaning and/or disinfecting all surfaces in the form of a compressed tablet containing an effervescing component, a germicidal agent, and a non-ionic surfactants, but free of any anionic surfactants, wherein the weight ratio of the basic ingredients to the acidic ingredients of the effervescing component is within a range of from about 1.0:1.0 to about 1.0:4.0.

### FIELD OF THE INVENTION

This invention relates generally to effervescent germicidal compositions for cleaning and disinfecting hard surfaces such as toilet.

### BACKGROUND OF THE INVENTION

Cleaning and/or disinfecting compositions for hard surfaces are known in the art and many products are available in the marketplace. Such products are generally in liquid or compressed tablet or powder form. However, each type has its respective shortcomings. For example, liquid disinfecting products may contain organic solvents or water, thus making them heavy for transport. On the other hand, long term storage of such products is not risk-free. Tablets and powder products may have a high-bulk capacity, which also demands for special storage capabilities and storage space.

Effervescent formulations have also been used in the sanitation industry, but so far, they have not provided the ideal germicidal profile desirable for disinfecting all hard surface areas.

U.S. Pat. No. 4,852,201 described a toilet bowl cleaner system directed to a tool that holds a cleaning pad. It also described a tablet or powder effervescent cleaning sanitizing composition for use with the toilet bowl. The composition included one or more surfactants, an alkali carbonate, an acid and a germicidal ingredient. U.S. Pat. No. 7,053,039 described a household cleaning composition in compressed form in conjunction with a germicidal agent. However, neither of these documents describe compositions having the comprehensive antimicrobial activity to effectively reduce the load of such bacteria as Enterococcus hirae, Escherichia Coli, Staphylococcus hirae and Pseudomonas aeruginosa. Accordingly, there is a need for an effervescent composition with a stronger germicidal activity. The present invention addresses such need in the art.

### SUMMARY OF THE INVENTION

The present invention provides for effervescent solid compositions for cleaning and/or disinfecting all surfaces with superior germ kill properties as compared to any effervescent. In another aspect of the present invention, the solid compositions are in the form of a compressed tablet that includes an effervescing component, a germicidal agent, and a surfactant selected from the group consisting of non-ionic surfactants, amphoteric surfactants, cationic surfactants, zwitterionic surfactants, and combinations thereof.

In one aspect of the present invention, the compressed solid composition according to the present invention is free of any anionic surfactants. The compressed solid composition according to the present invention may further include lubricants, colorants, perfumes, deodorizers, preservatives, dyes, disintegrants, binders, absorbents, and/or fillers. In at least certain embodiments, the present invention is directed to a solid effervescent composition for cleaning solid surfaces consisting essentially of a germicidal agent, a carbonate salt, a non-ionic surfactant, an organic acid or an inorganic acid, a disintegrant, a lubricant, a dye and a fragrance.

In some embodiments, the present compositions can be prepared in compressed solid form including for example, tablets, mini-tabs, blocks, rings, disks, stars, spheres, sticks, pellets, ribbons, and briquettes by combining an effervescent agent that contains an acidic component and a basic component with a germicidal agent into a solid composition.

In some embodiments, the effervescing component of the present compositions includes at least one acidic ingredient and at least one basic ingredient. In some embodiments, the acidic ingredient may be an organic or an inorganic acid. In some embodiments, the organic acid may be a carboxylic acid such as citric acid, tartaric acid, oxalic acid, adipic acid or mixtures thereof and the inorganic acid may be sulfamic acid. In certain embodiments, the acidic ingredients can range between about 10% to about 75% weight. In some embodiments, the acidic ingredients range between about 25% to about 65% weight. In other embodiments, the acidic ingredients range between about 35% to about 65% weight. In other embodiments, the acidic ingredient ranges between about 42.5% to about 62.5% weight. In other embodiments, the acidic ingredient ranges between 48% to 58% weight. In some preferred embodiments, the acidic ingredient may be in the range between 50% to 55% weight. In most preferred embodiment, the acidic ingredient ranges between 52.5% to about 54.5% weight of the solid composition.

In other embodiments, the basic component of the effervescent agent may be a carbonate salt present in the amount ranging between about 1% to about 60% weight of the composition in accordance to the present invention. In some embodiments, the carbonate salt is present in amount ranging between about 25% to about 40% weight. In some preferred embodiments, the carbonate salt is present in amount ranging between 27% to 35% weight. In some embodiments, the carbonate salt is any one or combinations of sodium bicarbonate, sodium carbonate, potassium bicarbonate, potassium carbonate, ammonium bicarbonate, and ammonium carbonate.

In some embodiments, the weight ratio of basic portion of the effervescent component to the acidic portion of the effervescing component is within a range of from about 1.0:1.0 to about 1.0:4.0. In some embodiments the weight ratio of basic portion to acidic portion is within a range of 1.0:1.3 to about 1.0:2.0. In some embodiments, the weight ratio of basic portion to the acid portion is 1.0:1.4 to about 1.0:1.75.

In a preferred embodiment, the present invention is an effervescent solid composition the form of a compressed tablet containing an effervescing component, a germicidal agent, and a non-ionic surfactant, but free of any anionic surfactants, wherein the weight ratio of the basic ingredients to the acidic ingredients of the effervescing component is within a range of from about 1.0:1.0 to about 1.0:4.0. In certain embodiments, the non-ionic surfactant is the sole surfactant in the composition.

In some embodiments, the germicidal agent is in the range between about 1 to about 20 weight % of the composition. In other embodiments, the germicidal agent is in the range of 3 to 15 weight % of the composition.

In some embodiments, the surfactant is a non-ionic surfactant, which is in the range of about 0.10% to about 10% by weight of the composition. In some embodiments, the non-ionic surfactant may be present in amounts ranging between about 0.5% to about 5%. In other embodiments, the non-ionic surfactant may be in the range of 0.75% to 3% by weight of the composition. In certain embodiment, the surfactants present in the instant compositions consist essentially of non-ionic surfactants. In certain embodiments, the surfactant consists of non-ionic surfactants. In certain embodiments, the surfactant is free of any anionic surfactants.

In certain embodiments, the effervescent solid germicidal composition of the present invention reacts with an aqueous solvent for up to 1, 3, 5, 10, 20, 30, 45, or 60 minutes to produce a stable foam. In certain embodiments, the solid compositions of the present invention when placed into an aqueous solvent having a suitable volume can form a stable foam that stays intact for at least 30 seconds, 1 min, 3 min, 5 min, 7 min, 10 min, 15 min, 20 min, or preferably 25 min, while maintaining at least a 0.10, 0.15, 0.25, 0.5, 0.8, 1.0, 1.2, 1.5, 1.8, 2.0, 2.5, 3.0, 3.5, 4.0, 5.0, 6.0, 7.5, 8.0, 9.0 cm height on top of the aqueous solvent having a temperature ranging from 17° C. to 25° C. In some embodiments, the solvent is water and the suitable volume depending on the container ranges between 0.10 to 3.5 liters, preferably between 0.8 to 2.7 liters, and more preferably between 1 to 2 liters. In some embodiments, the volume is about 1 liter, and a single solid composition according to the present invention can generate up to 0.50, 0.75, 1.0, 2.0, 5.0, 6.0, 8.0, 9.0 cm (1 cm=100 mm) of foam after 15 minutes of dissolution time per tablet.

In some embodiments, the compressed solid composition of the present invention dissolves quickly and continues to react with the water for up to about 1, 3, 5, 10, 20, 30, 45, or 60 minutes, resulting in a product with little or no residue in the vessel in which it is dissolved without the loss of disinfecting and/or sanitizing properties of the germicidal agent. In certain embodiments, the solid compositions of the present invention when placed into an aqueous solvent can form a stable foam that stays intact up to about 1 min, 3 min, 5 min, 7 min, 10 min, 15 min, 20 min, 25 min, 30 min, preferably up to about 45 min. In some embodiments, the vessel containing the aqueous solvent may contain an amount of solvent ranging from 0.100 liters to about 3.5 liters.

In another aspect, the present invention is directed to a foam product containing a germicidal agent, a non-ionic surfactant, a gas, and an aqueous solvent having a height of at least 0.1 cm to about 9 cm, which may be achieved during the dissolution time of a solid germicidal composition according to the present invention. In some embodiments, the dissolution time of said germicidal composition may be about 5, 20, 30, 45, or 60 minutes. In some embodiments, the height of the product foam according to the present invention is at least 0.5 cm to about 7.5 cm which is achieved within 5 to 12 minutes of the dissolution of the solid germicidal composition according to the present invention. In some embodiments, the present invention is directed to a stable foam composition having the stability of up to about 20 minutes produced by a process of (a) introducing the compressed solid composition according to the present invention, into an aqueous solvent, (b) forming a gaseous dispersion having a height ranging between 0.1 cm to about 5 cm, comprising a germicidal agent, a non-ionic surfactant and an and a gas over the surface of the solvent. In some embodiments, the stable foam composition achieves a germ load reduction by at least 2, 3 or 4 logarithmic scale after sufficient contact time with a hard surface.

In some embodiments, the solid composition according to the present invention may begin to disintegrate instantly or within up to one minute after being placed in a vessel containing an aqueous solution such as water and initiate the forming of a layer of foam.

In one aspect of the present invention, the solid compositions according to the present invention are suitable to effectively reduce the microorganism load of variety of hard surfaces including but not limited to countertops, floors, walls, sinks, toilets, toilet bowls, bathtubs, and the like. In some embodiments, the microorganism may include a bacterium, a fungus, a yeast, or a virus.

In another aspect, the present invention is directed to methods of reducing the bacterial load (number of cells) on a hard surfaces selected from the group consisting of toilet bowls, urinal, lavatory fixtures, bathroom and flooring tiles and floors by (a) introducing the compressed solid composition into an aqueous solvent such as a lavatory bowl, (b) forming a gaseous dispersion having a height ranging between 0.1 cm to about 7.5 cm, comprising a germicidal agent, a non-ionic surfactant and an and a gas over the surface of the solvent (c) applying the dispersion to the area of interest, (d) reducing the germ load by at least 2 logarithmic scale after sufficient contact time. In preferred embodiments, the present methods achieve a reduction in bacterial load by at least 3 decimal logarithms in 5 minutes, and/or at least 4 decimal logarithms in 7 minutes.

In another aspect, the compressed solid compositions of the present invention are effervescent compositions that can be placed into a vessel containing suitable amount of water, such as a toilet bowl or a bucket, to form a foam product or gaseous composition suitable to clean and disinfect at least three of the bacterial organisms selected from the group consisting of Enterococcus hirae, Escherichia coli, Staphylococcus aureus and Pseudomonas aeruginosa.

In other aspects, methods of manufacturing of the present solid compositions are described herein. In certain embodiments, the manufacturing is performed in a moisture control environment, wherein the relative amount of moisture is less than 20%, 10%, or preferably 1%.

### DETAILED DESCRIPTION OF THE INVENTION

### Definitions

To facilitate understanding of the disclosure set forth herein, a number of terms are defined below. Unless defined otherwise, all technical and scientific terms used herein have the same meaning as is commonly understood by one of skill in the art to which this invention belongs and shall be understood to have the meanings described below. All publications and patents referred to herein are incorporated by reference in their entirety. Unless otherwise specified, a reference to a particular compound includes all ionic, salt, solvate, protected forms, and other stereoisomers thereof, isomeric forms, including racemic and other mixtures thereof.

As used herein, “about” will mean up to plus or minus 1% of the respective term.

As used herein, “consisting essentially of” refers to the combination of ingredients listed in the claim and excludes addition of any active ingredients to the combination. It also excludes addition of any excipient that materially affect the basic and novel properties of the composition.

The term “effective amount” as used herein, pertains to that amount of an active compound, or a material, composition or dosage according to the present invention which is effective for producing the desired cleaning and/or disinfecting effects including germicidal and reduction of bacterial load and/or the microorganism cell count.

The term “effervescent” or “effervescence” refers to emitting small bubbles of gas continuously produced for a period of time.

The phrase “effervescent agent” as used herein refers to the combination of an acidic and basic component that are able to form a gaseous dispersion or foam when reacting with water.

The term “foam”, “foamy”, or “foaming” refers to a mass of frothy bubbles of air or gas in a matrix of liquid film such as a water surface that expands in size over time.

By the term “substantially free,” is meant that the final product contains less than 0.5% weight of the identified ingredient, while by the term “free,” it is meant that the final product is free of any traces of the identified ingredient to the extent that it could be detected by general quantitative assays known in the art for detection of such ingredient in the final product or if detected, it is in residual content of the ingredient and in principle only attributable to impurities.

By the term “stable foam” it is meant a foam that can stay intact for at least a specific duration of time minutes while maintaining a specific foam height over the solvent in which the effervescent agent may be reacting to form the foam. As such, a stable foam having the height of about 9 cm for a period of 10 minutes, refers to a foam layer having the height of about 9 cm above the surface of the solvent that stays stable or intact for at least 10 minutes.

The term “treatment” as used herein in the context of applying or treating the desired surface to the extent that a positive benefits are observed.

The term “vessel” is meant to include any reservoir, container or other volumetric component that can hold at least 100 milliliters (ml) of water.

The term “hard surface” is meant to include all variations of hard surface areas including but not limited to areas that are made of such material as bricks, ceramic, cement, crystal, diamond, glass, latex, marble, metallic, pebbles, porcelain, polymeric and quarry tiles, and natural stone.

The disclosure relates to the solid compressed effervescent compositions such as a tablet, mini-tablet, caplet, plurality of particles, powder, granules or the like in compressed solid form and methods of using such compositions to reduce the bacterial load and/or microorganism cell counts by at least 2, 3 or preferably 4, and more preferably 5 logarithmic scale, on hard surfaces as compared to the population of the same bacteria or microorganisms that might have existed on the surfaces before applying the instantly described compositions.

The inventors have surprising identified unique combinations of non-ionic surfactants and germicidal agents that can effectively disinfect and clean a hard surface area while providing a broad germicidal activity against organisms selected from the group consisting of Enterococcus hirae, Escherichia Coli, Staphylococcus aureus and Pseudomonas aeruginosa. In certain embodiments, such combination of ingredients is substantially free of any bleaching agent. In certain embodiments, such combination of ingredients is substantially free of any anionic surfactants such as carboxylates like alkylpolyoxycarboxylates. In certain embodiments, the combination further includes a disintegrant and a fragrance. In certain embodiments, the unique combinations according to the present invention is free of any bleaching agent and any anionic surfactants.

Accordingly, the present invention provides for effervescent solid compositions for cleaning and/or disinfecting all surfaces, preferably, in the form of a compressed tablet, that includes an effervescing component, a germicidal agent, and a surfactant. The solid composition according to the present invention may further include lubricants, colorants, perfumes, deodorizers, preservatives, dyes, disintegrants, binders, absorbents, and/or fillers. In at least certain embodiments, the present invention is directed to solid effervescent composition for cleaning solid surfaces consisting essentially of a germicidal agent, a carbonate salt, a non-ionic surfactant, an organic acid or an inorganic acid, a disintegrant, a lubricant, a dye and a fragrance. In at least certain embodiments, the present invention is directed to solid effervescent composition that is substantially free of any bleaching agent and any anionic surfactant. In at least certain embodiments, the present invention is free of any bleaching agent and any anionic surfactant.

In at least certain embodiments, the solid composition according to the present invention has a total weight ranging from about 0.05 grams (g) to about 500 g. In certain embodiments, the solid composition has a total weight ranging between about 10 g to about 100 g, preferably between 15 g to about 75 g, and more preferably between 20 g to about 50 g. In some preferred embodiments, the composition is in the form of a compressed tablet, wherein said tablet has a weight of between 10 g and 100 g, preferably between 15 g and 75 g, more preferably between 25 g and 45 g.

In some embodiments, the compositions of the present invention is placed into vessel having an aqueous solvent, initiating the formation of foam on the outermost layer of the aqueous solvent, allowing sufficient time for the foam to come in direct contact with the hard surfaces of interest, achieving at least a twofold reduction of the bacterial load (number of bacterial cells) of at least any three species of Enterococcus hirae, Escherichia Coli, Staphylococcus aureus and Pseudomonas aeruginosa. In some embodiments, the compositions of the present invention achieve a 4-log reduction of the bacterial load of all such species. In some embodiments, the compositions of the present invention achieve a 5-log reduction of the bacterial load of all such species.

In some embodiments, the tablets in accordance to the present invention have an overall hardness as measured by acceptable industry standards such as USP Test Method 1217 or using suitable tablet hardness tester equipment. As such, the load at fracture may be returned in kilopond's (kp). A kilopond is a metric unit of force measurement with 1 kp being equivalent to 9.807 Newtons. In some embodiments, using suitable tablet hardness tester, the hardness of the dosage forms ranges from about 0.2 to about 7.3 kp, about 0.7 to about 5.8 kp, about 1.5 to about 5.5 kp, or about 3 to about 5.2.

The tablets are also analyzed for their resistance to breaking using the tablet friability tests according to the industry standards, such as USP Test Method 1216 or other acceptable standards. In some embodiments, the friability weight loss measurement of the tablet is preferably less than 5 percent weight loss using 25 RPM ERWEKA par 220. In other embodiments, the friability weight loss is less than 4, 3, or preferably 2 percent weight loss.

In another aspect, the present invention is directed to methods of disinfecting hard surfaces by inserting the solid effervescent composition of the present invention is inserted into a liquid solvent, forming a foam and allowing sufficient contact time between the foam and the hard surface and reducing the bacterial load of the surface by at least 3 or 4 logarithmic scale.

In certain embodiments, the present invention is directed to methods of disinfecting hard surfaces by inserting the solid effervescent composition of the present invention is inserted into a liquid solvent, forming a foam having a height ranging between 0.5 cm to about 9 cm for at least a period ranging between 5 to 60 minutes, and allowing sufficient contact time between the foam and the hard surface and reducing the bacterial load of the surface by at least 3 or 4 logarithmic scale.

In yet another aspect of the present invention, an article of manufacture is used having a dispensing end, a compartment for storing a compressed solid composition comprising (a) a germicidal agent, (b) a carbonate salt, (c) a non-ionic surfactant and (d) an acid, wherein the solid composition is free of any bleaching agent. In such embodiments, the composition according to the present invention are wrapped in a moisture control packaging wherein the moisture content of the wrapped composition is less than 5%, preferably 2.5%, and more preferably less than 1%. In some embodiments, the wrapping material may be biodegradable.

### Effervescing Component:

The presence of the effervescing component in the compositions of the present invention helps to disintegrate the composition as to disperse the germicidal agent into the water content of the vessel. In some embodiments, the disintegration occurs when the effervescing component is added to water, causing a chemical reaction to release gas, such as carbon dioxide, which respectively forces the other compressed materials within the compressed form away from each other, causing dispersion of the materials within the vessel. Once effervescence is ended, the resulting solution is then available for cleaning the surfaces intended. The generation of carbon dioxide increases the rate of solution of the other portions and produces a solution in which the active ingredient, for example a germicidal agent, is homogeneously dissolved.

The effervescing component is typically made up of two types of ingredients: an acidic portion and a basic portion. When exposed to water, these ingredients react to form a gas. In one embodiment, the generated gas is carbon dioxide. The acidic portion according to the present invention may be selected from the group consisting of an organic acid, organic acid salts, organic acid anhydrides, inorganic acids, inorganic acid salts, and mixtures thereof. In some embodiments, the organic acid, and related salts and anhydrides are selected from carboxylic acids having up to 8 carbon atoms such as, for example acetic, formic, propionic, malic, tartaric, citric, glycolic, maleic, fumaric, adipic, succinic, lactic, gluconic, and butyric acids and their homologs. Examples of inorganic acid or acid salts include sulphamic acid. boric acid, sodium dihydrogen phosphate, disodium dihydrogen pyrophosphate, and sodium acid sulfite. Those of ordinary skill in the art will appreciate that under certain conditions, the type of acid ingredients to be used will depend upon the germicidal active substance to be incorporated into the compressed form such that the acid will not affect the activity or efficacy of the germicidal active substance.

In other embodiments, the selection of specific acids and/or salts and their proportions depends, at least in part, upon the amount of carbon dioxide to be released. In some embodiments, the acid may be added in an amount of about 10% to about 75% by weight of the effervescent component, while the basic salt may also be added in an amount of about 1% to about 60% weight of the composition in accordance to the present invention. In certain embodiments, the acid is in an amount of about 50% to about 70% by weight of the effervescent component, while the basic salt is in amount of about 25% to about 40% by weight of the effervescent component.

In some embodiments, the acidic portion of the effervescing component may be present in an amount ranging from about 10% to about 65% weight of the composition in compressed solid form in accordance to the present invention. In some embodiments, the acidic ingredients range between about 25% to about 65% weight of the solid composition. In other embodiments, the acidic ingredients range between about 35% to about 65% weight of the solid composition. In other embodiments, the acidic ingredient ranges between about 42.5% to about 62.5% weight. In other embodiments, the acidic ingredient ranges between 48% to 58% weight of the solid composition. In some preferred embodiments, the acidic ingredient may be in the range between 50% to 55% weight of the solid composition. In most preferred embodiment, the acidic ingredient ranges between 52.5% to about 54.5% weight of the solid composition.

The basic portion is preferably selected from the group consisting of carbonates, bicarbonates, sesquicarbonates and mixtures thereof. Preferably, any ammonium, alkali metal or alkali earth metal (for example, sodium, potassium, lithium, calcium, magnesium) carbonate, bicarbonate, sesquicarbonates or mixtures thereof may be used in compressed solid composition of the present invention. Potassium and sodium bicarbonate are preferred since they readily react with the acidic portion of the effervescent component to release an abundant amount of carbon dioxide as well as having good water solubility. In certain embodiments, the carbonate salt is selected from the group consisting of sodium bicarbonate, sodium carbonate, potassium bicarbonate potassium carbonate, ammonium bicarbonate, ammonium carbonate, and any combinations thereof.

The basic portion of the compositions described herein may be present in the amount ranging between about 1% to about 60% weight of the solid composition in compressed solid form. In some embodiments, the basic portion is present in amount ranging between about 25% to about 40% weight of the solid composition. In some preferred embodiments, the basic portion is selected from the group consisting of sodium carbonate, sodium bicarbonate or a combination thereof, in amount ranging from 30% to 37.5% weight of the solid composition. In certain embodiment, the basic portion is a combination of sodium bicarbonate to sodium carbonate at a weight ratio of 1:1.

In some embodiments, the ratio of basic portion to acidic portion of the effervescing component is within a range of from about 1.0:1.0 to about 1.0:4.0. In some embodiments the ratio of basic portion to acidic portion is within a range of 1.0:1.3 to about 1.0:2.0. In some embodiments, the ratio of basic portion to the acid portion is 1.0:1.4 to about 1.0:1.75. Accordingly, in one embodiment, the citric acid component may be about 54% while the amount of the sodium bicarbonate, sodium carbonate individually or together may be about 31%.

In some embodiments, the combination of acidic and basic portions collectively amounts to about 95% of the weight of the solid composition. In some embodiments, the acidic and basic portion is about 90% of the weight of the solid composition. In some preferred embodiments, the acid and basic portions amounts is in the range from 82.5% to 88.5% of the weight of the composition. In some embodiments, the combination of acidic and basic portions amount to 85% to 88% of the weight of the composition.

In preferred embodiment, the effervescing components are substantially free of any moisture. In some embodiments, the effervescent components and the rest of the components should be used, and the final compressed form should be stored, at a temperature of less than room temperature (25° C.) and at a relative humidity of less than 20%. In preferred embodiments, the composition according to the present invention is manufactured and stored at a relative humidity of less than 10%, 5%, 2% and preferably less than 1%.

### Germicidal Agents:

Germicidal compounds of the present invention include cationic compound biguanides, and phenolics. In some embodiments, the germicidal agents are either in powder form or if liquid, absorbed onto a carrier such that after doing so, the material now is a powder. Accordingly, in most preferred embodiment, the germicidal agents are mixed in powder form.

Cationic surfactants are found to provide a broad antibacterial or sanitizing function in the present invention. Any cationic surfactant which satisfies these requirements, provided they are in powder form or are absorbed onto a carrier so as to be in powder form, may be used and are considered to be within the scope of the present invention, and mixtures of two or more cationic surfactants may also be used. Cationic surfactants are well known, and useful cationic surfactants may be one or more of those described for example in McCutcheon's Detergents and Emulsifiers, North American Edition, 1998; Kirk-Othmer, Encyclopedia of Chemical Technology, 4th Ed., Vol. 23, pp. 478-541, and U.S. Pat. No. 7,053,049 the respective contents of which are herein incorporated by reference. Examples of preferred cationic surfactant compositions useful in the practice of the instant invention are those which provide a germicidal effect to the concentrate compositions, and especially preferred are quaternary ammonium compounds and salts thereof, which may be characterized by the general structural formula I:

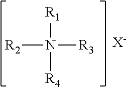

where at least one of R₁, R₂, R₃ and R₄ is an alkyl, aryl or alkylaryl substituent of from 6 to 26 carbon atoms, and the entire cation portion of the molecule has a molecular weight of at least 165. The alkyl substituents may be long-chain alkyl, long-chain alkoxyaryl, long-chain alkylaryl, halogen-substituted long-chain alkylaryl, long-chain alkylphenoxyalkyl, arylalkyl, etc. The remaining substituents on the nitrogen atoms other than the above mentioned alkyl substituents are hydrocarbons usually containing no more than 12 carbon atoms. The substituents R₁, R₂, R₃ and R₄ may be straight-chained or may be branched, but are preferably straight-chained, and may include one or more amide, ether or ester linkages. The counterion X may be any salt-forming anion which permits water solubility of the quaternary ammonium complex.

Exemplary quaternary ammonium salts within the above description include the alkyl ammonium halides such as cetyl trimethyl ammonium bromide, alkyl aryl ammonium halides such as octadecyl dimethyl benzyl ammonium bromide, N-alkyl pryridinium halides such as N-cetyl pyridinium bromide, and the like. Other suitable types of quaternary ammonium salts include those in which the molecule contains either amide, ether or ester linkages such as octyl phenoxy ethoxy ethyl dimethyl benzyl ammonium chloride, N-(laurylcocoaminoformylmethyl)-pyridinium chloride, and the like. Other very effective types of quaternary ammonium compounds which are useful as germicides include those in which the hydrophobic radical is characterized by a substituted aromatic nucleus as in the case of lauryloxyphenyltrimethyl ammonium chloride, cetylaminophenyltrimethyl ammonium methosulfate, dodecylphenyltrimethyl ammonium methosulfate, dodecylphenyltrimethyl ammonium chloride, chlorinated dodecylbenzyltrimethyl ammonium chloride, and the like.

Preferred quaternary ammonium compounds which act as germicides and which are found to be useful in the practice of the present invention include those which have the structural formula:

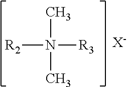

wherein R₂ and R₃ are the same or different C₈-C₁₂ alkyl, or R₂ is C₁₂₋₁₆ alkyl, C₈₋₁₈ alkylethoxy, C₈₋₁₈ alkylphenoxyethoxy and R₃ is benzyl, and X is a halide, for example chloride, bromide or iodide, or is a methosulfate or saccharinate anion. The alkyl groups recited in R₂ and R₃ may be straight-chained or branched, but are preferably substantially linear. Examples of quaternary ammonium compounds which are either in powder form or are absorbed onto a carrier such as urea include BTC2125M P40 (C₁₂₋₁₄ alkyl [(ethylphenyl)methyl]dimethyl, chlorides and, benzyl-C₁₂₋₁₈-alkyldimethyl, chlorides, each used at about 20%).

In some embodiments, the germicidal agent may be BTC 824 P-100 (alkyl dimethyl benzyl ammonium chloride), and alkyl dimethyl benzyl ammonium chloride such as BARQUAT MS-100 (benzyl-C₁₂₋₁₄-alkyldimethylammonium chlorides).

In some embodiments, the quaternary ammonium compound is selected from the group consisting of alkyldimethylbenzyl ammonium chloride, alkyldimethyl (ethylbenzyl) ammonium chloride, N-alkyl, N, N-dimethyl N benzyl ammonium, and mixtures thereof. In some embodiments, the quaternary ammonium compound is a combination of C₁₂₋₁₄ alkyl [(ethyl phenyl)methyl]dimethyl, chlorides and benzyl-C₁₂₋₁₈-alkyldimethyl, chlorides. In some embodiments each of the thereof. In some embodiments, the quaternary ammonium compound is a combination of C₁₂₋₁₄ alkyl [(ethylphenyl)methyl]dimethyl, chlorides and benzyl-C₁₂₋₁₈-alkyldimethyl, chlorides each used at about 20% by weight.

Other useful compounds are available under the BARDAC®, BARQUAT®, HYAMINE®), LONZABAC®, BTC®), and ONYXIDE® trademarks, which are more fully described in, for example, McCutcheon's Functional Materials (Vol. 2), North American Edition, 2000, and the respective product literature from the suppliers identified below. Although in liquid form, they can be placed on carriers to form a powder as discussed below.

For example, BARDAC® 205M is described to be a liquid containing alkyl dimethyl benzyl ammonium chloride, octyl decyl dimethyl ammonium chloride; didecyl dimethyl ammonium chloride, and dioctyl dimethyl ammonium chloride (50% active) (also available as 80% active (BARDAC® 208M); described generally in McCutcheon's as a combination of alkyl dimethyl benzyl ammonium chloride and dialkyl dimethyl ammonium chloride); BARDAC® 2050 is described to be a combination of octyl decyl dimethyl ammonium chloride/didecyl dimethyl ammonium chloride, and dioctyl dimethyl ammonium chloride (50% active) (also available as 80% active (BARDAC® 2080)); BARDAC® 2250 is described to be didecyl dimethyl ammonium chloride (50% active); BARDAC® LF (or BARDAC® LF-80), described as being based on dioctyl dimethyl ammonium chloride (BARQUAT® MB-50, MX-50, OJ-50 (each 50% liquid) and MB-80 or MX-80 (each 80% liquid) are each described as an alkyl dimethyl benzyl ammonium chloride; BARDAC® 4250 and BARQUAT® 4250Z (each 50% active) or BARQUAT® 4280 and BARQUAT® 4280Z (each 80% active) are each described as alkyl dimethyl benzyl ammonium chloride/alkyl dimethyl ethyl benzyl ammonium chloride. Also, HYAMINE®) 1622, described as diisobutyl phenoxy ethoxy ethyl dimethyl benzyl ammonium chloride (50% solution); HYAMINE® 3500 (50% actives), described as alkyl dimethyl benzyl ammonium chloride (also available as 80% active (HYAMINE® 3500-80); and HYAMINE® 2389 described as being based on methyldodecylbenzyl ammonium chloride and/or methyldodecylxylene-bis-trimethyl ammonium chloride. (BARDAC®), BARQUAT®) and HYAMINE®) are presently commercially available from Lonza, Inc., Fairlawn, N.J.). BTC® 50 NF (or BTC®) 65 NF) is described to be alkyl dimethyl benzyl ammonium chloride (50% active); BTC® 99 is described as didecyl dimethyl ammonium chloride (50% active); BTC®) 776 is described to be myristalkonium chloride (50% active); BTC® 818 is described as being octyl decyl dimethyl ammonium chloride, didecyl dimethyl ammonium chloride, and dioctyl dimethyl ammonium chloride (50% active) (available also as 80% active (BTC®) 818-80%)); BTC® 824 and BTC® 835 are each described as being of alkyl dimethyl benzyl ammonium chloride (each 50% active); BTC®) 885 is described as a combination of BTC® 835 and BTC® 818 (50% active) (available also as 80% active (BTC® 888)); BTC® 1010 is described as didecyl dimethyl ammonium chloride (50% active) (also available as 80% active (BTC® 1010-80)); BTC® 2125 (or BTC® 2125 M) is described as alkyl dimethyl benzyl ammonium chloride and alkyl dimethyl methylbenzyls ammonium chloride (each 50% active) (also available as 80% active (BTC® 2125 80 or BTC® 2125 M)); BTC®) 2565 is described as alkyl dimethyl benzyl ammonium chlorides (50% active) (also available as 80% active (BTC® 2568)); BTC® 8248 (or BTC® 8358) is described as alkyl dimethyl benzyl ammonium chloride (80% active) (also available as 90% active (BTC® 8249)); ONYXIDE® 3300 is described as n-alkyl dimethyl benzyl ammonium saccharinate (95% active). (BTC® and ONYXIDE® are presently commercially available from Stepan Company, Northfield, Ill.). Polymeric quaternary ammonium salts based on these monomeric structures are also considered desirable for the present invention. One example is POLYQUAT®, described as being a 2-butenyldimethyl ammonium chloride polymer. Other cationic surfactants suitable for use in the present invention are also set forth in the Examples below.

As mentioned above, if the quaternary ammonium compounds are in liquid form, they need to be absorbed on to a carrier so that they become a powder. Suitable carriers include those mentioned below as fillers or bulking agents, carbonates, urea and the like, provided that carrier does not affect the activity of the quaternary ammonium compounds. In some embodiments, the carrier may be prepared in submicron particle structures containing plurality of pores in the outer surface between pore openings of said plurality of pores, and a cationic surfactant sitting on the surface of said outer surface. In some embodiments, such surfaces may be made of silica, a polysaccharide, cellulose or cellulose derivatives, or other bulking agent having particle diameter size of less than 1000 nm.

Another material having disinfecting or sanitizing properties include polymeric biguanide materials such as polyhexamethylene biguanide, available from Avecia as Vantocil 100. In addition, the polymeric biguanides described in U.S. Pat. Nos. 4,652,585, 3,428,576, Great Britain Patent Specification No. 702,268, and European Patent Application 485 07943, the content of which are respectively incorporated herein by reference in relevant part, may be used in the present invention.

Phenolic based germicidal agents can also be used in the present invention and those of ordinary skill in the art will take certain factors into consideration when selecting an appropriate phenolic in view of a proposed effervescent agent system. This selection process is well within the skill of an ordinary person. As with the quaternary ammonium compounds, if the phenolics are not in powder form, they need to be absorbed on to a carrier to then become in powder form. Examples of phenolic based germicidal agents include hexachlorophene, tetrachlorophene, 2,3 dihydroxy-5,5′-dichlorodiphenyl-sulfide, 2,2′-dihydroxy-3,3′,5,5′-tetrachlorodiphenyl sulfide, 2,2′-dihydroxy-3,5′,5,5′,6,6′-hexachlorobiphenyl sulfide, and 3,3′-dibromo-5,5′-dichloro-2,2′-dihydroxydiphenylamine, dichlorophene, chlorbutanol, glyceryl laurate, halogenated diphenyl ethers, 2,4,4′-trichloro-2′-hydroxy-diphenyl ether (Triclosan® or TCS), 2,2′-dihydroxy-5,5′-dibromo-diphenyl ether, phenolic compounds, phenol, 2-methyl phenol, 3-methyl phenol, 4-methyl phenol, 4-ethyl phenol, 2,4-dichlorophenol, p-nitrophenol, 2,4-dimethyl phenol, 2,5-dimethyl phenol, 3,4-dimethyl phenol, 2,6-dimethyl phenol, 4-n-propyl phenol, 4-n-butyl phenol, 4-n-amyl phenol, 4-tert-amyl phenol, 4-n-hexyl phenol, 4-n-heptyl phenol, mono- and poly-alkyl and aromatic halophenols, p-chlorophenol, methyl p-chlorophenol, ethyl p-chlorophenol, n-propyl p-chlorophenol, n-butyl p-chlorophenol, n-amyl p-chlorophenol, sec-amyl p-chlorophenol, n-hexyl p-chlorophenol, cyclohexyl p-chlorophenol, n-heptyl p-chlorophenol, n-octyl p-chlorophenol, o-chlorophenol, methyl o-chlorophenol, ethyl o-chlorophenol, n-propyl o-chlorophenol, n-butyl o-chlorophenol, n-amyl o-chlorophenol, tert-amyl o-chlorophenol, n-hexyl o-chlorophenol, n-heptyl o-chlorophenol, o-benzyl p-chlorophenol, o-benzyl-m-methyl p-chlorophenol, o-benzyl-m, m-dimethyl p-chlorophenol, o-phenylethyl p-chlorophenol, o-phenylethyl-m-methyl p-chlorophenol, 3-methyl p-chlorophenol, 3,5-dimethyl p-chlorophenol, 6-ethyl-3-methyl p-chlorophenol, 6-n-propyl-3-methyl p-chlorophenol, 6-iso-propyl-3-methyl p-chlorophenol, 2-ethyl-3,5-dimethyl p-chlorophenol, 6-sec-butyl-3-methyl p-chlorophenol, 2-iso-propyl-3,5-dimethyl p-chlorophenol, 6-diethylmethyl-3-methyl p-chlorophenol, 6-iso-propyl-2-ethyl-3-methyl p-chlorophenol, 2-sec-amyl-3,5-dimethyl p-chlorophenol, 2-diethylmethyl-3,5-dimethyl p-chlorophenol, 6-sec-octyl-3-methyl p-chlorophenol, o-benzylphenol, p-chloro-o-benzylphenol, 4-phenolsulfonic acid cresols (o-, m-, p-), p-chloro-m-cresol, p-bromophenol, methyl p-bromophenol, ethyl p-bromophenol, n-propyl p-bromophenol, n-butyl p-bromophenol, n-amyl p-bromophenol, sec-amyl p-bromophenol, n-hexyl p-bromophenol, cyclohexyl p-bromophenol, o-bromophenol, tert-amyl o-bromophenol, n-hexyl o-bromophenol, n-propyl-m,m-dimethyl o-bromophenol, 2-phenyl phenol, 4-chloro-2-methyl phenol, 4-chloro-3-methyl phenol, 4-chloro-3,5-dimethyl phenol, 2,4-dichloro-3,5-dimethylphenol, 3,4,5,6-tetrabromo-2-methylphenol, 5-methyl-2-pentylphenol, 4-isopropyl-3-methylphenol, para-chloro-meta-xylenol, chlorothymol, phenoxyethanol, phenoxyisopropanol, 5-chloro-2-hydroxydiphenylmethane, resorcinol and its derivatives, resorcinol, methyl resorcinol, ethyl resorcinol, n-propyl resorcinol, n-butyl resorcinol, n-amyl resorcinol, n-hexyl resorcinol, n-heptyl resorcinol, n-octyl resorcinol, n-nonyl resorcinol, phenyl resorcinol, benzyl resorcinol, phenylethyl resorcinol, phenylpropyl resorcinol, p-chlorobenzyl resorcinol, 5-chloro 2,4-dihydroxydiphenyl methane, 4′-chloro 2,4-dihydroxydiphenyl methane, 5-bromo 2,4-dihydroxydiphenyl methane, 4′-bromo 2,4dihydroxydiphenyl methane, bisphenolic compounds, 2,2′-methylene bis(4-chlorophenol), 2,2′-methylene bis(3,4,6-trichlorophenol), 2,2′-methylene bis(4-chloro-6-bromophenol), bis (2 hydroxy-3,5-dichlorophenyl) sulphide, bis(2-hydroxy-5-chlorobenzyl) sulphide, benzoic esters parabens such as methylparaben, propylparaben, butylparaben, ethylparaben, isopropylparaben, isobutylparaben, benzylparaben, sodium methylparaben, sodium propylparaben, halogenated carbanilides, 3,4,4′-trichlorocarbanilides (Trichlocarban® or TCC), 3-trifluoromethyl-4,4′-dichlorocarbanilide, and 3,3′,4-trichlorocarbanilide.

In some embodiments, the composition according to the present invention contains at least one germicidal agent in amounts ranging between 1 to 20% weight of the composition; preferably in amounts ranging between 2 to 15% weight of the composition. In preferred embodiments, the germicidal agent is in amounts 3 to 11% and selected from the group consisting of Alkyl dimethyl ammonium chloride, alkyl dimethyl (ethylbenzyl) ammonium chloride and combinations thereof.

### Surfactants:

Surfactants which can be used in the present invention are selected from the group consisting of nonionic surfactants, amphoteric, and mixtures thereof. The nonionic surfactants may be straight-chain or branched and are preferably ethoxylated for increased water solubility. Nonionic surfactants are well known in the detergency art, however, at least one aspect of the present invention, is the surprising and unexpected identification of the suitable non-ionic surfactants that can provide the desired foaming activity as well as allowing the germicidal agent to provide desirable germicidal activity. For example, Glucopon 50G which has an anionic component or has anionic surfactant properties, is incompatible with BTC 2125 P40 quaternary cationic germicide and does not provide an optimal combination. On the other handle, Lutensol AT50, also a non-ionic surfactant is compatible with BTC 2125 P40, while allowing desirable foaming.

Accordingly, at least one point of novelty in this case, is the surprising finding that certain non-ionic surfactants such as Lutensol AT (a C₁₆₋₁₈ fatty alcohol ethoxylate) provide a foaming activity that when combined with suitable quaternary germicidal agent, achieves the desired disinfecting activities. In some embodiments, the preferred non-ionic surfactant is C₁₆₋₁₈ fatty alcohol ethoxylate or a derivative thereof. In certain embodiments, the sole surfactant present in the formulation is a non-ionic surfactant. In some embodiments, the sole surfactant is a C₁₆₋₁₈ fatty alcohol ethoxylate. In certain embodiments, the preferred embodiment, facilitates formation of a foamy froth on top of the aqueous solvents used according to the present invention wherein the foamy froth may stay stable for at least 2, 3, 5, 10, 20 or 45 min having at least a height of about 2, 2.5, 5, or 7.5 cm.

In some embodiments, the composition is substantially free of any anionic surfactant. In some embodiments, the non-ionic surfactant has less than 2%, 1% or 0.5% of anionic content. In some embodiments, the composition is free of any anionic surfactants in the solid effervescent composition.

The suitable surfactants that may be included in the compositions of the present invention together with the other components are defined hereinabove. Nonlimiting examples of suitable nonionic surfactants which may be used in the present invention are as follows:
(1) C₁₆₋₁₈ fatty alcohol ethoxylate (Lutensol AT25, 25 moles EO BASF; Lutensol AT50 (50 moles EO; BASF; Lutensol AT80, 80 moles EO; BASF).
(2) The polyethylene oxide condensates of alkyl phenols. These compounds include the condensation products of alkyl phenols having an alkyl group containing from about 6 to 12 carbon atoms in either a straight chain or branched chain configuration with ethylene oxide, the ethylene oxide being present in an amount equal to 5 to 25 moles of ethylene oxide per mole of alkyl phenol. The alkyl substituent in such compounds can be derived, for example, from polymerized propylene, diisobutylene and the like. Examples of compounds of this type include nonyl phenol condensed with about 9.5 moles of ethylene oxide per mole of nonyl phenol; dodecylphenol condensed with about 12 moles of ethylene oxide per mole of phenol; dinonyl phenol condensed with about 15 moles of ethylene oxide per mole of phenol and diisooctyl phenol condensed with about 15 moles of ethylene oxide per mole of phenol.
(3) The condensation products of aliphatic alcohols with from about 1 to about 60 moles of ethylene oxide. The alkyl chain of the aliphatic alcohol can either be straight or branched, primary or secondary, and generally contains from about 8 to about 22 carbon atoms. Examples of such ethoxylated alcohols include the condensation product of myristyl alcohol condensed with about 10 moles of ethylene oxide per mole of alcohol and the condensation product of about 9 moles of ethylene oxide with coconut alcohol (a mixture of fatty alcohols with alkyl chains varying in length from about 10 to 14 carbon atoms). One example of such a nonionic surfactant is available as Empilan KM 50.
(4) Alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.
(5) One group of such useful nonionic surfactants containing the characteristic alkylene oxide blocks are those which may be generally represented by the Formula (A):

HO-(EO)ₓ(PO)_{y}(EO)_{z}—H Formula(A)

where
EO represents ethylene oxide,
PO represents propylene oxide,
y equals at least 15,
(EO)_{x+y} equals 20 to 50% of the total weight of said compounds, and, the total molecular weight is preferably in the range of about 2000 to 15,000. These surfactants are available under the PLURONIC tradename from BASF.
(6) Another group of nonionic surfactants appropriate for use in the new compositions can be represented by the Formula (B):

R-(EO,PO)ₐ(EO,PO)_{b}—H Formula(B)

wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.
(7) Further nonionic surfactants which in general are encompassed by Formula B include butoxy derivatives of propylene oxide/ethylene oxide block polymers having molecular weights within the range of about 2000-5000.
(8) Still further useful nonionic surfactants containing polymeric butoxy (BO) groups can be represented by Formula (C) as follows:

RO—(BO)ₙ(EO)ₓ—H Formula(C)

wherein
R is an alkyl group containing 1 to 20 carbon atoms,
n is about 5-15 and x is about 5-15.
(9) Also useful as the nonionic block copolymer surfactants, which also include polymeric butoxy groups, are those which may be represented by the following Formula (D):

HO-(EO)ₓ(BO)ₙ(EO)_{y}—H Formula(D)

wherein
n is about 5-15, preferably about 15,
x is about 5-15, preferably about 15, and
y is about 5-15, preferably about 15.
(10) Still further useful nonionic block copolymer surfactants include ethoxylated derivatives of propoxylated ethylene diamine, which may be represented by the following Formula (E):

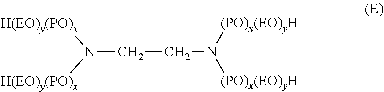

### Where

(EO) represents ethoxy,
(PO) represents propoxy,
   the amount of (PO)ₓ is such as to provide a molecular weight prior to ethoxylation of about 300 to 7500, and the amount of (EO)_{y} is such as to provide about 20% to 90% of the total weight of said compound.
(11) Amphoteric surfactants may also be used in the present invention. Amphoteric surfactants are those surfactants whose acidic or basic character is pH dependent. Depending on the pH, amphoteric surfactants may behave either as an anionic surfactant, a cationic surfactant, or both. Preferably the amphoteric surfactants are water soluble betaine surfactants. Examples of suitable betaine surfactants are dodecyldimethylammonium acetate, tetradecyldimethylammonium acetate, hexadecyldimethylammonium acetate, alkyldimethylammonium acetate, dodecyldimethylammonium butanoate, tetradecyldimethylammonium butanoate, hexadecyldimethylammonium butanoate, dodecyldimethylammonium hexanoate, tetradecyldiethylainmonium pentanoate, tetradecyldipropylammonium pentanoate, dodecylmethylammonium acetate, dodecyldimethylammonium hexanoate, and hexadecyldimethylammonium hexanoate. Preferred amphoteric betaine surfactants include, but are not limited to, lauramidopropyl betaine and cocamido betaine.

In preferred embodiments, the non-ionic surfactant is substantially free of any anionic surfactant. In some embodiments, the non-ionic surfactant has less than 2%, 1% or 0.5% of anionic content. In most preferred embodiment, the non-ionic surfactant is free of any anionic surfactant or anionic impurities.

In some embodiments, the present invention is directed to a specific ratio of the concentrations of the germicidal agent and the surfactants. For example, in scenarios when the non-ionic surfactant is used in the solid composition, then the ratio between the weight % concentrations of germicidal agent and the non-ionic surfactant is between 1:4, 1:3, 1:2, 1:1, 2:1, 4:1,15:1. In other embodiments, the ratio of the concentrations between the germicidal agent and the non-ionic surfactant in the solid composition is between 1:2 to 4:1 In other embodiments, the ratio of the concentrations between the germicidal agent and the non-ionic surfactant in the solid composition is between 2.2:1. For example in some embodiments where the germicidal agent is BTC 2125 M P40 and the non-ionic surfactant is a C₁₆₋₁₈ fatty alcohol ethoxylate such ratio may respectively be 10.5:1 and 11:1.

### Other Excipients:

The compressed form of the present invention may also contain a binder and/or disintegrant. Use of a binder helps to hold the tablet together, thus enabling it to be made using a lower compaction pressure and making it inherently more likely to disintegrate well in the wash liquor. If the binder is also a material that causes disruption when contacted with water (in which case it is a disintegrant), even better disintegration properties may be achieved when used with the effervescing agent.

Materials which can be binders and/or disintegrants include organic materials such as starches, for example, corn, maize, rice and potato starches and starch derivatives, such as carboxymethyl starch, modified or pregelatinized starch and sodium starch glycolate; celluloses and cellulose derivatives, for example, sodium carboxymethyl cellulose, cross-linked modified cellulose, and microcrystalline cellulosic fibres; natural gums (for example, acacia, tragacanth, carrageenan, xanthan, agar, guar, locust bean, karaya, pectin, gellan); sugars (for example, glucose, sucrose); and various synthetic organic polymers, notably polyethylene glycol, polyvinylalcohol, polyvinylacetate and crosslinked polyvinyl pyrrolidone, and crosslinked polyacrylic acid. Inorganic swelling disintegrants include bentonite clay. It will also be appreciated that such material can also be filler material for the compressed form.

The binder or the disintegrant is preferably used in an amount within the range of from 0.1 to 10 weight %, more preferably from 1 to 5 weight % of the composition. In certain embodiments, microcrystalline cellulose or derivatives thereof may be used as disintegrant in amounts of 1, 2, or 3 weight %.

Lubricants, which prevent the compressed form from sticking to the form press, can be added in amounts up to about 0.5%. Suitable lubricants include glyceryl monostearate, or other fatty ester of glycerines, polyethylene glycol and boric acid, talc, colloidal silicas and the like

Perfumes, dyes, and colorants are optional materials in the compressed form and when used, may be present in an amount of up to about 5 weight percent of the composition for perfume, but preferably in the ranges of 0.1 to about 0.9 weight percent of the composition. Dyes and colorants may be used for up to about 2 weight percent of the composition. Those of ordinary skill in the art will appreciate that the type and amount of perfume, dye, and colorant used in the present invention will be of the type and in the amount so as not to have a deleterious effect on the compressed form. In addition, if any perfume, dye or colorant is in liquid form, it will have to be absorbed onto a carrier so as to make it a powder.

Those of ordinary skill in the art will appreciate that some components, for example, binders, may have properties of, for example, a disintegrant when placed within the compressed form. In addition, additional materials can be incorporated into the compressed form, for example, fillers (for example, zeolites, lactose, phosphates (with which certain disintegrants (for example, Acusol 771) is useful)), absorbers (a useful example of which is Microsponge, which is a polymer in addition to silica gels, alumina gels, and the like), and the like, the use and identification of which are well known to those of ordinary skill in the art.

In some embodiment the composition according to the present invention has a total weight of about 0.05 g to about 500 g. In some preferred embodiments, the composition is in the form of a compressed tablet, wherein said tablet has a weight of between 10 g and 100 g, preferably between 15 g and 80 g, more preferably between 22.5, 25 g and 45 g.

### Foam Product:

At least one aspect of the present invention is directed to the excellent foamability characteristics of the solid effervescent compositions according to the present invention. The composition is generally in the “foam phase” when at least 1% by volume of the initial volume of the applied composition may be characterized by a “foam” consistency.

In some embodiments, the foam according to the present invention is formed by a process of dry mixing and blending the powder forms of germicidal agent, a carbonate salt, a non-ionic surfactant and the acidic ingredient, all in powder forms, in a vessel to obtain particle size ranging from 100 micrometers to about 900 micrometers, compressing the resulting powder blend into a mold die and applying hydraulic press to form a compressed effervescent solid composition such as a tablet. The compressed effervescent tablet is then inserted into an aqueous solvent and dissolved, in at least 100 ml of an aqueous solvent for sufficient amount of time, forming a gaseous dispersion. In certain embodiments, the germicidal agent concentration in the final foam product is from 0.2 g per 100 ml to about 10 g per 100 ml.

In some embodiments, upon insertion of the present solid compositions in an aqueous solvent, the gas forming reaction begins which can take up to 1, 3, 5, 10, 20, 30, 45, or 60 minutes to produce a stable foam of a foam phase. In certain embodiments, the solid compositions of the present invention when placed into an aqueous solvent can form a stable foam that stays intact for at least 30 seconds, 1 min, 3 min, 5 min, 7 min, 10 min, 15 min, 20 min, or preferably 25 min, while maintaining at least a 0.10, 0.15, 0.25, 0.5, 0.8, 1.0, 1.2, 1.5, 1.8, 2.0, 2.5, 3.0, 3.5, 4.0, 5.0, 6.0, 7.5, 8.0, 9.0, 12, 15 cm height on top of the aqueous solvent, wherein the amount of solid tablet may be from about 20 g to about 45 g.

In some embodiments, the generated foam contains carbon dioxide gas which maintains the integrity of the foam. In certain embodiments, the foam may have a height ranging from about 0.25 cm to about 15 cm sitting above and on top of the aqueous solvent in which it has been formed. In certain embodiments, the foam may have a height of about 0. 0.10, 0.15, 0.25, 0.5, 0.8, 1.0, 1.2, 1.5, 1.8, 2.0, 2.5, 3.0, 3.5, 4.0, 5.0, 6.0, 7.5, 8.0, 9.0 12, 15 cm sitting on top of the aqueous solvent. In certain embodiments, the solid compositions of the present invention when placed into an aqueous solvent can form a stable foam that stays intact up to about 1 min, 3 min, 5 min, 7 min, 10 min, 15 min, 20 min, 25 min, 30 min, preferably up to about 45 min. In certain embodiments, the weight of the solid composition may be in the range from 20 grams to 50 grams forming the foamy froth on top of the aqueous solvents used according to the present invention wherein the foamy froth may stay stable for at least 2, 3, 5, 10, 20, or 45 min having at least a height of about 2.0 to about 7.5 cm. In certain embodiments, the solid composition may range between 22.5 to 45 grams weight. In other embodiments, the solid composition may be 25 grams weight.

In some embodiments, the compressed solid composition of the present invention dissolves quickly and continues to react with the water for up to about 1, 3, 5, 10, 20, 30, 45, or 60 minutes, resulting in a product with little or no residue in the vessel in which it is dissolved without the loss of disinfecting and/or sanitizing properties of the germicidal agent. In some embodiments, the vessel containing the aqueous solvent may contain an amount of solvent ranging from 100 ml to about 1000 ml.

In another aspect, the present invention is directed to a foam product containing a germicidal agent, a non-ionic surfactant, a gas, and an aqueous solvent having a height of at least 0.25 cm to about 15 cm, which may be achieved during the dissolution time of a solid germicidal composition according to the present invention. In some embodiments, the dissolution time of said germicidal composition may be about 5, 20, 30, 45, or 60 minutes. In some embodiments, the height of the product foam according to the present invention is at least 0.5 cm to about 7.5 cm which is achieved within 5 to 12 minutes of the dissolution of the solid germicidal composition according to the present invention.

In certain embodiments, the formed foam composition contains a non-ionic surfactant, a germicidal agent, a gas, and optionally a dye and a fragrance. In some embodiment, the formed foam or the foam phase consist essentially of a non-ionic surfactant, a germicidal agent, a gas, and optionally a dye and a fragrance. In some embodiments, the non-ionic surfactant is a C₁₆₋₁₈ fatty alcohol ethoxylate and the gas is carbon dioxide, air or a combination thereof.

In certain embodiments, the effervescent solid germicidal composition of the present invention reacts with an aqueous solvent for up to 30 seconds, 1 minute, 5 minutes, 10 minutes, 20 minutes, 30 minutes, 45 minutes, or 60 minutes to produce the stable foam. In some embodiments, when the solid compositions of the present invention are placed into an aqueous solvent can form a stable foam or a gaseous dispersion that stays intact for at least 30 seconds to preferably about 25 min, while maintaining at least a height ranging from about 0.25 cm to about 15 cm on top of the aqueous solvent.

In some embodiments, certain embodiments, the gas may be air, carbon dioxide, or a combination thereof. In some embodiments, the foam contains no foam stabilizer. As such, the compressed solid composition of the present invention dissolves quickly in the aqueous solvent such as water and continues to react with the water for up to about 1, 5, 7, 10, 12, 15, 20, 30, 45, or 60 minutes, resulting in a product with little or no residue in the vessel in which it is dissolved without the loss of disinfecting and/or sanitizing properties of the germicidal agent.

In some embodiments, the formulation may contain a foam stabilizer that regulates the length of time the composition remains in a foam phase after it is applied with relatively higher amounts of foaming stabilizer corresponding to longer periods of time the composition remains as a foam and vice versa.

Generally, the foam composition will disintegrate into a liquid composition over time. The foam product according to the present invention preferably stays stable for at least 1, 5, 10, 15, 30, 45 or 60 minutes. In certain embodiments the foam product according to the present invention stays stable for a period of up to 5, 10, 15, 30, 45, 60 or 90 minutes. In preferred embodiments, the formulation produces a foam height of about 0.5 cm, 0.6 cm, 0.8 cm, 1 cm, 2 cm, 4 cm, 6 cm, 7 cm, and/or 7.5 cm and maintains such height after 5, 15, 20 or 30 minutes after formation.

In some embodiments, the generated foam contains carbon dioxide gas which maintains the integrity of the foam. In certain embodiments, the foam may have and maintain a height of about 5 cm, 4.5 cm, 4.0 cm, 3.5 cm, 3.0 cm, 2.5 cm, 2.0 cm, or 1 cm for at least a duration of 1, 3, 5, 10, 15, 30, 45 or 60 minutes after its formation. The foam stabilizer may slow the rate at which the foam disintegrates. In some embodiments, the composition may include at least about 0.01% foam stabilizer by weight and, in another embodiment, at least about 0.05% foam stabilizer by weight. In various embodiments, the pesticide composition includes from about 0.05% to about 1% foam stabilizer by weight of the composition, from about 0.08% to about 0.5% or from about 0.08% to about 0.15% foam stabilizer by weight of the composition.

In some embodiments, the foam stabilizer may be a thickening agent, such as a compound selected from the group consisting of xanthan gum, guar gum, gum arabic, alginin, gum tragacanth, sodium alginate and mixtures thereof. In another embodiment, the foam stabilizer and thickening agent are xantham gum. In embodiments where the thickening agent and the foam stabilizer are the same compound or series of compounds, the compound(s) may be present in the composition in the amounts listed above relating to the thickening agent or the foam stabilizer.

In various other embodiments, the composition is capable of remaining in a foam phase for from about 30 seconds to about 1 hour after application or from about 5 minutes to about 45 minutes after application. In some embodiments, it is desirable for the composition to be capable of remaining in a foam phase for at least about 30 minutes after application in order to increase the germicidal activity. In some other embodiments, the composition is capable of remaining in a foam phase for at least about 5 minutes to up to about 1 hour after application. By remaining in the foam phase, the quaternary compound or the germicidal agent remains suspended within the site of interest longer which allows for the germicide and the cleaning or disinfecting agent to remain evenly dispersed within or across the hard surface site if interest.

In other embodiments, the foam phase may remain in the foam phase for less than about 15, 30 or 45 minutes after application. In certain embodiments, the foam may have a height ranging from about 1.0 cm to about 10 cm sitting above and on top of the aqueous solvent in which it has been formed which stays stable for a time window ranging between 5 to about 60 minutes. In some embodiments, the foam may have a height of 2 cm, 2.5 cm, 3.0 cm, 3.5 cm, 4.0 cm, 4.5 cm, 5.0 cm, 6 cm, or 7.5 cm and stays at such size for at least 5, 10, 15, 20, 25, 30, 35, 40, or 45 minutes. In some embodiments, the foam may break down or disintegrates relatively quickly on the hard surface of choice to promote the drying of the treatment area.

The foam stability for the compositions of the present invention is done by measuring the foam height from the level of the standing water in the beaker containing about 1 liter of water to the top of foam level at 5 mins dissolution time, 10 mins dissolution time and so on till the tablet is fully dissolved at 20 degree C. (19° C.-21° C.—water temp) and continue to be measured up to about 90 minutes.

### Method of Reducing Microorganism Load on a Hard Surface:

In at least one aspect, the present invention is directed to a method for reducing bacterial load or the cell counts of any other pathogenic or non-pathogenic microorganisms on a hard surface of interest including applying the effervescent compressed solid composition of the present invention into a vessel containing a solvent, allowing the formation of a foam phase or a gaseous dispersion, wherein he foam contains a non-ionic surfactant, a germicidal agent, and optionally a dye and a suitable fragrance. In some embodiments, the method further includes the step of allowing sufficient contact time between the hard surface and the foam phase. In some embodiment, the duration of contact time may vary from 30 seconds to 60 minutes after the formation of the foam. In certain embodiment, the contact time is 3 minutes. In other embodiments, the contact time is 5 minutes and yet in other embodiments, the contact time may be 10 minutes. In some embodiments, the gaseous dispersion having a height of 0.10, 0.15, 0.25, 0.5, 0.8, 1.0, 1.2, 1.5, 1.8, 2.0, 2.5, 3.0, 3.5, 4.0, 5.0, 6.0, 7.5, 8.0, 9.0 cm, formed over the surface of the solvent and further stays stable and intact for at least a duration of ranging between 30 seconds to 60 minutes.

In certain embodiments, the rate the compositions of the present invention provide a comprehensive antibacterial activity after sufficient time of exposure by reducing any or all of the desired bacterial, fungal or yeast organism. In certain embodiments, the bacterial is selected from the group consisting of Staphylococcus aureus, Enterococcus hirae, Pseudomonas aeruginosa and Escherichia coli. In other embodiments, the method of the present invention reduces the fungi and yeast activity of organisms selected from the group consisting of C. albicans and/or A. brasiliensis. In some embodiment, the comprehensive antibacterial activity may be achieved after 3, 5, 10, 15, 20, 30 or 60 minutes.

In one embodiment, the methods of the present invention achieve at least a 2, 3, 4 or 5 log reductions for the respective microorganism such as bacteria, virus, or fungi or yeast. In certain embodiment, the bacterial load is reduced by at least 4 logarithmic scale. In other embodiments, the fungi or yeast load may be reduced by at least a 3-log reduction from the level that might have been present prior to the application of the instant compositions according to the present invention. In certain embodiments, the reduction of microorganism load is assessed in accordance with the acceptable standards known in the art acceptable by a respective regulatory agency. In some embodiments, the standard is in accordance with European test method EN13697, EN 1276, EN 1650, EN 14476, EN 13704.

In a preferred embodiment, the present methods achieve a 4 decimal log reduction of at least three strains of the following four strains: (a) Pseudomonas aeruginosa ATCC 15 4421); (b) Staphylococcus aureus ATCC 6 538; (c) Enterococcus hirae ATCC 10 541; (d) Escherichia coli ATCC 10 536; (c) E. faecium ATCC 6057 (f) Salmonella typhimurium ATCC 13311, (g) Lactobacillus brevis DSM 6235, and (h) Enterobacter cloacae DSM 6234. In most preferred embodiment, the present methods achieve a 4 decimal log reduction of all four strains of the following four strains of (a) Pseudomonas aeruginosa ATCC 15 4421; (b) Staphylococcus aureus ATCC 6538; (c) Enterococcus hirae ATCC 10541, (d) Escherichia coli ATCC 10536. In preferred embodiments, the bacterial strains are Pseudomonas aeruginosa; Staphylococcus aureus; Enterococcus hirae; and Escherichia coli. In certain embodiments, the bacterial load of all four strains is reduced by at least 3 decimal logarithms in 3, 5, 7, 10, 15 or 20 minutes. In other embodiments, the bacterial load of all four strains is reduced by at least 4 decimal logarithms in 1, 3, 5, 7, 10, 15, 20, 30, or 45 minutes after application to the hard surface of interest.

In certain embodiments, the present methods also achieve a reduction of fungal and yeast activities by at least 2 or 3 decimal logs of the following two strains: (a) Candida albicans ATCC 10 231; and (b) Aspergillus brasiliensis (ex A. niger) ATCC 16 404. In other embodiments, the present methodology further achieves a reduction of the bacterial load of such strains as Salmonella typhimurium ATCC 13311; Lactobacillus brevis DSM 6235; Enterobacter cloacae DSM 6234; and Saccharomyces cerevisiae (for breweries) or ATCC 9763 or DSM 1333. In certain embodiments, the reduction of any or all of such strains may be achieved in 3, 5, 7, 10, 15, 20, 30, or 45 minutes. In preferred embodiments, the present methods achieve a reduction in bacterial load by at least 3 decimal logarithms in 5 minutes, and/or at least 4 decimal logarithms in 7 minutes.

### Examples

Examples of compositions of the present invention, compressed into tablets, are set forth below in Tables 1-3 below. The products in the following Examples are prepared by mixing the solid products and compressed into the final solid form directly. The process of manufacturing the tablet begins with initially premixing the carbonate components of the powder with the fragrance and coloring agent in a low mixing energy environment to create the first blend. Citric acid, silica and Magnesium stearate is then dry mixed for at least 3-5 minutes and then added to a blend of Lutensol, quaternary ammonium and the first blend to obtain powder particle size ranging from 100 nm to about 8000 nm, preferably between 250 nm to 5000 nm. Furthermore, the manufacturing occurs at a moisture control environment, wherein moisture content is less than 5%, 2.5%, preferably 1%, more preferably 0.5%.

At least one unique feature in the instant process is creating the first blend to improve flowability prior to adding the other ingredients. Powder components generally have the propensity to form hard lumps which are difficult to break up and can cause flowability issues at tableting phase. To that end, the sequence of dry mixing must be considered to avoid flowability issues.

In the present case, the powder product prepared by the method of the present invention produce a powder product that is substantially free flowing. The term “substantially free flowing” as used herein means that the lumps in powder blend are substantially friable, which allows the mixed blend to flow substantially without manual intervention. Flowability measurements of the powder products made according to the present steps of introducing 200 grams of powder premix in a funnel and measure the time it takes for all of the powder to flow out. In a preferred embodiment, the flow rate for the 200 grams of the powder is about 10 seconds. In one embodiment, the particle size of the powder ranges between 100 to 900 micrometers. In a preferred embodiment, 90% of the particle of the powder have a size ranging between 250 micrometers to 850 micrometers.

Tableting is then accomplished by compressing the resulting powder blend into a mold die and applying hydraulic press to form a compressed tablet. The compression force for compacting the powder ranges between 0.5 ton to 22 tons, preferably in the range of 7 tons to 15 tons. The compressed forms were made under standard conditions for making effervescent compressed forms (for example, less than about 25° C. and less than 20%, preferably 10% or 5% relative humidity) using suitable press such as hydraulic tablet press, a Korsch, Carver or Kilian press. The amounts of materials used are on a weight percent of weight of the tablet formed, as set out in Tables 1-3. The materials were used “as is” basis as received from the supplier.

TABLE 1

| Component | Ex | Ex | Ex | Ex | Ex | Ex | Ex | Ex |
|---|---|---|---|---|---|---|---|---|
| (% W/W) | 1A/532A | 1B/560 | 2/532B | 3/532C | 4A/559 | 4/17 | 5/39 | 6/40 |
| Na bicarbonate | 33.5 | 31.12 | 33.5 | 30.0 | 15.66 | 50.00 | 50.00 | 50.00 |
| Na carbonate | | | | | 15.66 | 17.69 | 16.18 | 18.88 |
| Citric Acid | 54.06 | 54.06 | | 57.56 | 54.60 | 25.00 | 25.00 | 25.00 |
| Citracoat | | | | | | | | |
| Sulfamic Acid | | | 54.06 | | | | | |
| BTC 2125M P40 | 11.0 | 11.0 | 11.0 | 11.0 | 11.0 | | 3.75 | |
| BTC 824 P-100 | | | | | | 3.16 | | 1.05 |
| Lutensol AT 25 | | | | | | | | |
| Lutensol AT 50 | 1.0 | 2.0 | 1.0 | 1.0 | 2.0 | | | |
| Glucopon 50 G | | | | | | 2.0 | 2.00 | 2.00 |
| Polyplasdone XL | | | | | | 2.0 | | |
| Atrocel TF 30 HG | | | | | | | 3.00 | 3.00 |
| Mg Stearate | | 1.0 | | | 1.0 | | | |
| Silica | | 0.4 | | | 0.4 | | | |
| Fragrance | 0.40 | 0.4 | 0.40 | 0.4 | 0.4 | 0.15 | 0.08 | 0.08 |
| Dye | 0.04 | 0.02 | 0.04 | 0.04 | 0.02 | | | |
| Total | 100 | 100 | 100 | 100 | 100 | 100 | 100 | 100 |
| weight (grams) | 45 | 45 | 45 | 45 | 45 | 35 | 35 | 35 |

TABLE 2

| Component | Ex | Ex | Ex | Ex | Ex | Ex |
|---|---|---|---|---|---|---|
| (% W/W) | 8/89 | 9/116 | 10/117 | 11/208 | 12/211 | 14/215 |
| Na bicarbonate | 33.51 | 28.38 | 28.38 | 40.00 | 40.00 | 40.00 |
| Na carbonate | 10.00 | 10.00 | 10.00 | 10.00 | 10.00 | 10.00 |
| Citric Acid | 25.54 | 21.62 | 21.62 | 10.00 | 10.00 | |
| Citracoat | | | | | | 10.00 |
| Sulfamic Acid | | | | | | |
| BTC 2125M P40 | 11.0 | | | | | |
| BTC 824 P-100 | | | | | | |
| Barquat MS-100 | 1.8 | 9.00 | | 1.80 | 1.80 | 1.80 |
| Vantocil 100 | | | 4.50 | | | |
| Prismalac 40 | 10.00 | 11.20 | 13.45 | 9.20 | 12.21 | 11.73 |
| Karion | 15.00 | 11.20 | 13.45 | 9.20 | 12.21 | 11.73 |
| Lutensol AT 25 | | | | | | 6.00 |
| Pluronic F68 | | 2.00 | 2.00 | 5.10 | 2.55 | |
| Pluronic F38 | | | | 6.95 | 3.48 | |
| Hexylcellosove | | 2.00 | 2.00 | | | |
| on microspone | | | | | | |
| Hysorb P 9070 | | | | | | 0.25 |
| Hysorb P 7050 | | | | 0.25 | 0.25 | |
| Avicel NT 050 | | | | 3.00 | 3.00 | 4.00 |
| PEG 6000 | 3.00 | | | 3.00 | 3.00 | 3.00 |
| PEG 4000 | 1.00 | | | 1.00 | 1.00 | 1.00 |
| PEG 1500 | | 1.00 | 1.00 | | | |
| Sipernat 22 | 0.08 | | | | | |
| Fragrance | 0.08 | 0.60 | 0.60 | 0.50 | 0.50 | 0.50 |
| Dye | | | | | | |
| Total | 100 | 100 | 100 | 100 | 100 | 100 |
| Tablet weight | 25 | 10 | 10 | 10 | 10 | 10 |
| (grams) | | | | | | |

TABLE 3

| Component | Ex | Ex | Ex |
|---|---|---|---|
| (% W/W) | 15/216 | 16/217 | 18/219 |
| Na bicarbonate | 40.00 | 40.00 | 40.00 |
| Na carbonate | 10.00 | 10.00 | 10.00 |
| Citric Acid | | | |
| Citracoat | 10.00 | 10.00 | 10.00 |
| Sulfamic Acid | | | |
| BTC 2125M P40 | | | |
| BTC 824 P-100 | | | |
| Barquat MS-100 | 1.80 | 1.80 | 1.80 |
| Prismalac 40 | 11.73 | 11.73 | 12.48 |
| Karion | 11.73 | 11.73 | 12.48 |
| Lutensol AT 25 | 6.00 | | |
| Lutensol AT 50 | | 6.00 | |
| Lutensol AT 80 | | | 4.50 |
| Pluronic F68 | | 2.00 | 5.10 |
| Pluronic F38 | | | 6.95 |
| Hysorb P 9070 | 0.25 | 0.25 | 0.25 |
| Hysorb P 7050 | | | |
| Avicel NT 050 | 4.00 | 4.00 | 4.00 |
| PEG 6000 | 3.00 | 3.00 | 3.00 |
| PEG 4000 | 1.00 | 1.00 | 1.00 |
| PEG 1500 | | | |
| Sipernat 22 | 0.08 | | |
| Fragrance | 0.50 | 0.50 | 0.50 |
| Dye | | | |
| Total | 100 | 100 | 100 |
| Tablet size | 10 | 10 | 10 |
| (grams) | | | |

The materials used in above examples are described in Table 4 below.

TABLE 4

| Component | Description |
|---|---|
| Citric Acid | Citric acid anhydrous |
| Citracoat | Coated citric acid |
| BTC 2125M P40 | Alkyl dimethyl ammonium chloride |
| | and alkyl dimethyl (ethylbenzyl) |
| | ammonium chloride (Stepan) (40%) |
| Barquat MS-100 | N-alkyl, N, N dimethyl N-benzyl |
| | ammonium (Lonza)(100%) |
| BTC 824 P-100 | N-alkyl, N, N dimethyl N-benzyl |
| | ammonium (Stepan)(40%) |
| Prismalac 40 | Monohydrate lactose |
| Karion | Sorbitol (Merci) |
| Lutensol AT 25 | C₁₆₋₁₈ fatty alcohol ethoxylate (25 moles |
| | EO, BASF) |
| Lutensol AT 50 | C₁₆₋₁₈ fatty alcohol ethoxylate (50 moles |
| | EO, BASF) |
| Lutensol AT 80 | C₁₆₋₁₈ fatty alcohol ethoxylate (80 moles |
| | EO, BASF) |
| Glucopon 50 G | Alkyl polyglycoside (Cognis) |
| Polyplasdone XL | PVP (ISP) |
| Atrocel TF 30 HG | Amorphous Cellulose (Rohm Hoss) |
| Pluronic F68 | Ethylene oxide/propylene oxide block |
| | copolymers containing about 3 moles |
| | of propylene oxide condensed with |
| | about 8 moles of ethylene oxide |
| | (BASF) |
| Pluronic F38 | Ethylene oxide/propylene oxide block |
| | copolymers containing about 25-30 |
| | moles of propylene oxide condensed |
| | with about 33-41 moles of ethylene |
| | oxide (BASF) |
| Hysorb P 9070 | Grafted sodium polyacrylate |
| Hysorb P 7050 | Grafted sodium polyacrylate |
| PEG 6000 | Polyethylene glycol with ave. |
| | molecular weight of 6000 (BASF) |
| PEG 4000 | Polyethylene glycol with ave. |
| | molecular weight of 4000 (BASF) |
| PEG 1500 | Polyethylene glycol with ave. |
| | molecular weight of 1500 (BASF) |

Certain compositions of Tables 1, 2 and 3 were tested for antimicrobial activity under European test method EN13697, surface test suspension method, issued by the European Committee for Standardization, Brussels, as amended on June 2019. This test describes a method for establishing whether a product proposed as disinfectant has the bactericidal and/or fungicidal or yeasticidal activity on non-porous surfaces, closely simulating practical conditions of application.

Accordingly, a test suspension of the bacteria or the fungi of choice is prepared in a solution of a 3.0 g/l bovine albumin. For determining the antibacterial activity, the bacteria includes Staphylococcus aureus, Enterococcus hirae, Pseudomonas aeruginosa and Escherichia coli. To assess the yeasticidal or fungicidal activity a 3.0 g/l bovine albumin for C. albicans and/or A. brasiliensis is used. The solution is inoculated onto a test stainless steel surface and dried. A prepared sample (45 grams of the test product diluted in 1.1 liter of water) of the test product The surface is maintained at a specified temperature for a defined period of time. The surface is transferred to a previously validated neutralization medium so that the action of the disinfectant is immediately neutralized. The number of surviving organisms which can be recovered from the surface is determined quantitatively. The number of bacteria or fungi on a surface treated with hard water in place of the disinfectant is also determined and the reduction in viable counts attributed to the product is calculated by difference.

To pass this test, the product undergoing this test shall demonstrate at least a 4 decimal log reduction for bacteria and at least a 3 decimal log reduction for fungi or yeast when tested in accordance with the respective applicable parameters. As such, the test is passed if the bacterial colonies forming units (cfu) are reduced from a 107 cfu (initial level) to a 103 cfu (final level after contact with the disinfecting product), a 104 reduction.

In certain embodiments, the bactericidal activity shall be evaluated using the following four strains: (a) Pseudomonas aeruginosa ATCC 15 4421); (b) Staphylococcus aureus ATCC 6 538; (c) Enterococcus hirae ATCC 10 541; (d) Escherichia coli ATCC 10 536. In the case of the fungicidal or yeasticidal activity, the evaluation may be made using the following two strains: (e) Candida albicans ATCC 10 231; and (f) Aspergillus brasiliensis (ex A. niger) ATCC 16 404. If required for specific applications, additional strains may be chosen from, for example other organisms such as: Salmonella typhimurium ATCC 13 311; Lactobacillus brevis DSM 6 235; Enterobacter cloacae DSM 6 234; Saccharomyces cerevisiae (for breweries) or ATCC 9 763 or DSM 1333;

Several of the compositions of the present invention were evaluated under established European test method EN1276 for evaluating antimicrobial efficacy of the compositions. The results of the micro testing are found in Table 5.

| Example # of | E. | E. | S. | p. |
|---|---|---|---|---|
| product tested | hirae | coli | aureus | aeruginosa |
| 1/532A | Pass | Pass | Pass | Pass |
| 1/532B | Pass | Pass | Pass | Pass |
| 1/532C | Pass | Pass | Pass | Pass |
| 5/39 | NE* | Fail | NE | Fail |
| 5/40 | Fail | Fail | NE | Fail |
| 9/117 | Fail | NE | NE | NE |
| 15/216 | NE | NE | NE | NE |

*Not Evaluated

The tablets according to the present invention were also evaluated for their foam generating capabilities. Examples 1B/560 and 4A/559 particularly provided superior foaming properties as compared to its counterparts. To assess foamability, a single tablet for each example were mixed in a 2 L beaker filled with 1100 ml tap water. The amount and height of the foam generated on top of the water surface was then measured with a ruler. Accordingly, the foam height measured from the level of the standing water in the beaker to the top of foam level at 5 mins dissolution time, 10 mins dissolution time and once the tablet is fully dissolved at 20 degree C. (19° C.-21° C.—water temp), were measured. Table 6 below provides the results of the foam height indicating superior results compared to the counterpart embodiments.

TABLE 6
Foaming results

| | Foam height (mm) | | |
|---|---|---|---|
| After 5 minutes | 60 | 60 | 80 |
| After 10 minutes | 390 | 360 | 330 |
| After 15 minutes | 690 | 630 | 600 |
| At the end of the complete | 760 | 640 | 690 |
| dissolution of the tablet | | | |
| Time of dissolution | 19 min 30″ | 17 min 58″ | 20 min 40″ |

While the invention is susceptible of various modifications and alternative forms, it is to be understood that specific embodiments thereof have been shown by way of example which are not intended to limit the invention to the particular forms disclosed; on the contrary the intention is to cover all modifications, equivalents and alternatives falling within the scope and spirit of the invention as expressed in the appended claims. Various references such as patents, patent applications, and publications are cited herein, the disclosures of which are hereby incorporated by reference herein in their entireties.

1. A solid composition for cleaning solid surfaces comprising (a) an effervescing component comprising at least one acidic ingredient and at least one basic ingredient; (b) a germicidal agent; and (c) a non-ionic surfactant, wherein the composition contains less than 0.5%, of any anionic surfactant and any bleaching agent and in the presence of an aqueous solvent produces a foam.

2. The solid composition of claim 1, wherein the acidic ingredient is selected from the group consisting of citric acid, tartaric acid, oxalic acid, adipic acid, sulfamic acid and mixtures thereof, and the basic ingredient is a carbonate salt.

3. The solid composition according to claim 1, wherein the acidic ingredient in said effervescent component is present in an amount ranging between 50% to 55%; and/or the carbonate salt in said effervescent component is present in the amount ranging between 25% to 40% weight, wherein the weight ratio of the basic to the acidic portions of the effervescing component is in the range from 1.0:1.3 to 1.0:2.0.

4. The composition according to claim 1, wherein the germicidal agent is present in the ranges between 3 to 11 weight % of the composition;
and/or the surfactant is a non-ionic surfactant and is present in the amount ranging between 0.25% to 10% weight of the composition.

5. The composition according to claim 1, wherein the germicidal agent is a quaternary ammonium compound that is selected from the group consisting of alkyldimethylbenzyl ammonium chloride, alkyldimethyl (ethylbenzyl) ammonium chloride, N-alkyl, N, N-dimethyl N benzyl ammonium, and mixtures thereof.

6. The composition according to claim 1, wherein the carbonate salt is selected from the group consisting of sodium bicarbonate, sodium carbonate, potassium bicarbonate, potassium carbonate, ammonium bicarbonate, ammonium carbonate, and any combinations thereof.

7. The composition according to claim 1, wherein the non-ionic surfactant is a C₁₆₋₁₈ fatty alcohol ethoxylate.

8. The composition according to claim 1, further comprising a filler, a binding agent, a fragrance, a dye, a preservative, a pH adjuster, a dispersant, and/or a lubricant.

9. The composition according to claim 1, wherein the composition is in the form of a tablet, a mini-tablet, compressed powder, or a plurality of granules; preferably wherein the composition is a tablet.

10. The composition according to claim 1, wherein the weight ratio of the germicidal agent concentrations to the non-ionic surfactant concentrations is between 1:4, 1:3, 1:2, 1:1, 2:1, 4:1, 15:1 weight ratio, respectively and the ratio of the basic ingredients to the acidic ingredients of the effervescing component is within a range of from about 1.0:1.0 to about 1.0:4.0.

11. A foam composition comprising (a) a germicidal agent, (b) a non-ionic surfactant, (c) a solvent and (d) a gas, wherein said gas is air, carbon dioxide, or a mixture thereof.

12. The foam composition of claim 11, wherein the foam has a height selected from the group consisting of 1 cm, 2 cm, 2.5 cm, 3.0 cm, 3.5 cm, 4.0 cm, 4.5 cm, 5.0 cm, 6 cm, 7.5 cm and any combinations thereof.

13. The foam composition according to claim 11, wherein the foam stays stable at said height for at least 1, 5, 10, 15, 20, 25, 30, 35, 40, or 45 minutes up to about 60 minutes.

14. The foam composition according to claim 11, formed by a process comprising (a) dry mixing and blending the powder forms of germicidal agent, a carbonate salt, a non-ionic surfactant and an organic acid, in a vessel to obtain particle size ranging from 100 micrometers to 900 nm, (b) compressing the resulting powder blend into a mold die and applying hydraulic press to form a compressed tablet and (c) dissolving the resulting compressed tablet in at least 100 ml of an aqueous solvent for sufficient amount of time, (d) forming a gaseous dispersion or a foam phase.

15. A method of reducing the bacterial load on a hard surfaces selected from the group consisting of toilet bowls, urinal, lavatory fixtures, bathroom and flooring tiles and floors by (a) introducing the solid composition of claim 1 into an aqueous solvent, (b) forming a gaseous dispersion having a height ranging between 0.1 cm to 5 cm, comprising a germicidal agent, a non-ionic surfactant and an and a gas over the surface of the solvent (c) applying the dispersion to the area of interest, (d) achieving a bacterial load reduction by at least 2 logarithmic scale after sufficient contact time of at least 30 seconds.

16. The method of claim 15, wherein the hard surfaces is of material selected from the group consisting bricks, ceramic, cement, crystal, diamond, glass, latex, marble, metallic, pebbles, porcelain, polymeric and quarry tiles, and natural stone.

17. The method of claim 15, wherein the bacterial organisms are at least four selected from the group consisting of Pseudomonas aeruginosa, Staphylococcus aureus; Enterococcus hirae; Escherichia coli; Salmonella typhimurium; Lactobacillus brevis; Enterobacter cloacae; and Saccharomyces cerevisiae, preferably wherein the bacterial organisms are Pseudomonas aeruginosa; Staphylococcus aureus; Enterococcus hirae; and Escherichia coli.

18. The method according to claim 15, wherein the bacterial load is reduced by at least 3 decimal logarithms in 5 minutes, preferably wherein the bacterial load is reduced by at least 4 decimal logarithms in 7 minutes.
